(19) United States
(12) Patent Application Publication
(10) Pub. No.: US 2025/0297698 A1
(43) Pub. Date: Sep. 25, 2025

(54) SEALING DEVICE HAVING A TOGGLE LEVER UNIT

(71) Applicant: BAUCONNECT GMBH & CO. KG, Monheim (DE)

(72) Inventor: Winfried Felber, Monheim (DE)

(21) Appl. No.: 19/088,001

(22) Filed: Mar. 24, 2025

(30) Foreign Application Priority Data
Mar. 25, 2024 (DE) 10 2024 108 435.9
Apr. 25, 2024 (DE) 10 2024 111 712.5

(51) Int. Cl. F16L 21/04

(52) U.S. Cl. CPC F16L 21/04

(57) ABSTRACT

In one aspect, a sealing device for sealing an annular gap includes a pressing unit configured to apply an axial force in an axial direction of the sealing device and a sealing unit. The sealing include includes at least one sealing element, which is configured to be pressed by the pressing unit outwards and/or inwards in a radial direction of the sealing device. Additionally, the sealing device includes at least one toggle lever unit having at least one toggle lever, which is configured to convert the axial force that applied by the pressing unit into a first radial force and/or into a second radial force, wherein the at least one toggle lever includes a first lever element, a second lever element, and at least one lever joint that hingedly interconnects the first and second lever elements.

### CROSS-REFERENCE TO RELATED APPLICATIONS

The present application is based upon and claims the right of priority to German Patent Application No. 10 2024 108 435.9, filed Mar. 25, 2024 and German Patent Application No. 10 2024 111 712.5, filed Apr. 25, 2024, the disclosures of which are hereby incorporated by reference herein in their entirety for all purposes.

### FIELD OF THE INVENTION

The present subject matter relates to a sealing device for sealing an annular gap, in particular an annular space seal, and/or for sealingly connecting two pipes, in particular a pipe coupling, having a pressing unit by means of which an axial force can be applied in an axial direction of the sealing device, having a sealing unit which includes at least one sealing element (e.g., at least one elastic sealing element), which can be pressed by the pressing unit, when used as intended, outwards and/or inwards in a radial direction of the sealing device. The present subject matter further relates to a toggle lever unit for such a sealing device.

### BACKGROUND OF THE INVENTION

The conventional annular space injection seals are suitable for sealing coring drill holes or casings for one or more cables. They can compensate only for minimum tolerances, however. Injection seals having sealing rings or compensation rings require that the rings be cut out or pulled out in accordance with the application but do not offer stepless adjustment since this depends on the thickness of the rings.

EP 3 091 261 B1 discloses a sleeve adapter. In this application, an expansion element has multiple toggle levers, which are arranged around a pipe section. A ring is used to fix a toggle lever in the axial direction on the pipe section. The toggle lever has two rigidly interconnected lever arms, wherein, when the expansion element is in the home position, the first lever arm is remote from the pipe section and the second lever arm extends close to the pipe section. The expansion element can be brought into a clamping position by actuating an outer portion of the second lever arm.

### SUMMARY OF THE INVENTION

In various aspects, the problem(s) of the prior art is/are addressed by the present subject matter by eliminating the disadvantages known from the prior art.

Specifically, in various aspects, the problem(s) of the prior art is/are addressed by a sealing device and a toggle lever unit having the features described and claimed herein. Advantageous or preferred embodiments are the subject matter of one or more of the claims presented herein.

In one aspect, the present subject matter relates to a sealing device for sealing an annular gap, in particular an annular space seal, and/or for sealingly connecting two pipes, in particular a pipe coupling. The sealing device includes a pressing unit by means of which an axial force can be applied in the axial direction of the sealing device. The sealing device also has a sealing unit which includes at least one sealing element (e.g., at least one elastic sealing element), which can be pressed by the pressing unit, when used as intended, outwards and/or inwards in a radial direction of the sealing device. The sealing device includes at least one toggle lever unit having at least one toggle lever, which, when used as intended, can convert the axial force that can be applied by the pressing unit into a first radial force (e.g., a radially inwardly directed radial force) and/or into a second radial force (e.g., a radially outwardly directed radial force). The at least one toggle lever has one first lever element, one second lever element, and at least one lever joint. The at least one lever joint hingedly interconnects the two lever elements. Advantageously, the sealing device can therefore implement, in particular in a radially inward direction and/or a radially outward direction, large to very large continuous diameter adjustments, preferably without the aid of sealing rings and/or compensation rings, in order to interconnect two pipes and/or to be able to seal an annular gap between a pipe or cable and a wall opening. Furthermore, very high pressing forces can be generated by means of the at least one toggle lever, as a result of which a very good sealing effect can be ensured.

It is advantageous when the pressing unit has one first pressing element, in particular on a first end face of the sealing device, and/or one second pressing element, in particular on a second end face of the sealing device.

It is advantageous when the first pressing element and the second pressing element are spaced apart from one another in the axial direction of the sealing device.

It is advantageous when the first pressing element and/or the second pressing element are in the form of press rings, which preferably include multiple, in particular interconnected, ring segments.

Furthermore, it is advantageous when the first pressing element and/or the second pressing element includes at least one receiving recess on the axial inner end face of the pressing element, in which receiving recess a sealing projection of the sealing unit is accommodated.

It is advantageous when the receiving recess is a blind hole.

It is also extremely advantageous when the receiving recess in the first pressing element and/or in the second pressing element has an axial sealing surface, which corresponds to a sealing end face of the sealing projection.

It is particularly advantageous when the pressing unit includes at least one fixing element, which interconnects the two pressing elements in such a way that the axial length is variable.

Furthermore, it is advantageous when the fixing element includes a screw and/or a nut.

It is also advantageous when the first pressing element and/or the second pressing element has at least one axial through-cutout through which the fixing element extends.

Similarly, it is advantageous when the through-cutout extends from an axial outer end face to the axial inner end face of the pressing element.

It is particularly advantageous when the through-cutout and the receiving recess are coaxial and/or adjoin one another and/or are located directly adjacent to one another.

Similarly, it is advantageous when the first pressing element has one first axial pressing surface and/or the second pressing element has one second axial pressing surface.

It is also advantageous when the first axial pressing surface and/or the second axial pressing surface includes an, in particular radially outer, first axial pressing region and/or an, in particular radially inner, second axial pressing region.

Similarly, it is advantageous when the first axial pressing region extends parallel to a radial axis of the sealing device in a longitudinal sectional view of the sealing device.

It is also advantageous when the second axial pressing region extends obliquely to the radial axis in the longitudinal sectional view of the sealing device, in particular such that an axial width of the first pressing element and/or of the second pressing element widens in the radially inward direction.

It is advantageous when the second axial pressing region is a ring projection projecting in the axial direction, which ring projection preferably extends in a circumferential direction of the sealing device over the entire circumference of the sealing device.

It is particularly advantageous when the sealing device is movable between a neutral position and a sealing position to which axial force is applied.

Similarly, it is advantageous when the two pressing elements, when in the neutral position with respect to one another, have one first axial separation and/or the two lever elements of the at least one toggle lever have one first exterior angle, in particular of less than or equal to 180°, to each other.

It is also extremely advantageous when the two pressing elements, when in the sealing position, have one second axial separation which is smaller in comparison to the first axial separation, and/or the two lever elements of the at least one toggle lever have one second exterior angle which is smaller in comparison to the first angle.

It is also advantageous when the first lever element and/or the second lever element is a lever arm which extends preferably in the axial direction of the sealing device.

Similarly, it is advantageous when the at least one toggle lever includes, in particular in the region of the lever joint of the toggle lever, at least one inner pressing portion for transmitting the first radial force and/or at least one outer pressing portion for transmitting the second radial force.

It is advantageous when the inner pressing portion has a pressing edge which extends preferably in a circumferential direction of the sealing device and/or has a roll-off rounding.

It is particularly advantageous when the outer pressing portion has a pressing surface, which extends obliquely to the radial axis of the sealing device in the longitudinal sectional view of the sealing device, in particular in the neutral position and/or sealing position of the sealing device.

Similarly, it is advantageous when the pressing surface of the toggle lever and the adjacent second axial pressing region of the corresponding pressing element extend radially inwards toward one another in a V-shape.

It is particularly advantageous when the first lever element has one first inner pressing portion, in particular in the region of the first end of the first lever element facing the lever joint, and/or one first outer pressing portion, in particular in the region of the second end of the first lever element facing away from the lever joint.

It is advantageous when the second lever element has one second inner pressing portion, in particular in the region of the first end of the second lever element facing the lever joint, and/or one second outer pressing portion, in particular in the region of the second end of the second lever element facing away from the lever joint.

It is similarly advantageous when the first lever element and/or the second lever element has at least one receiving cavity on the radial inner side of the lever element, in which receiving cavity the sealing unit, in particular a compensation fold extending in the circumferential direction, is at least partially accommodated and/or, at least in the sealing position of the sealing device, can be accommodated.

It is also advantageous when the receiving cavity is an annular groove which extends preferably in the circumferential direction of the sealing device over the entire circumference of the sealing device.

It is also advantageous when the first lever element and/or the second lever element has, on the radial inner side thereof, a first receiving cavity and/or a second receiving cavity, which are spaced apart from one another in the axial direction of the sealing device.

Similarly, it is advantageous when a separating element is formed on the first lever element and/or on the second lever element in the axial direction of the sealing device between the first receiving cavity and the second receiving cavity.

It is also advantageous when the at least one lever joint is a flexural joint, in particular a material joint, and/or a rotary joint.

Moreover, it is advantageous when an axis of rotation of the at least one lever joint is oriented in a transverse direction of the sealing device.

Similarly, it is advantageous when the at least one toggle lever includes one first lever joint and one second lever joint, which are preferably spaced apart from one another in the axial direction of the sealing device.

It is particularly advantageous when the at least one toggle lever includes a spacer element, which is located between the two lever joints in the axial direction and decouples the two lever joints from one another and/or spaces the two lever joints apart from one another.

It is also extremely advantageous when the spacer element has one first leg, one second leg, and/or one connecting portion which, in particular rigidly, connects the two legs to one another.

It is particularly advantageous when the spacer element has a V-shape in the longitudinal sectional view of the sealing device.

Furthermore, it is advantageous when the toggle lever unit has one first toggle lever and one second toggle lever. Preferably, the first toggle lever and/or the second toggle lever is designed according to the preceding description, wherein the aforementioned features can be present individually or in any combination. Additionally or alternatively, it is advantageous when the two toggle levers are spaced apart from one another in the circumferential direction of the sealing device.

It is also advantageous when a movement cavity is formed between the first toggle lever and the second toggle lever in the circumferential direction of the sealing device.

Furthermore, it is advantageous when the movement cavity is designed such that the lever elements and/or lever joints of the two toggle levers can move into the movement cavity when the sealing device is moved from the neutral position of the sealing device into the sealing position of the sealing device.

It is also advantageous when the first toggle lever and the second toggle lever are connected via at least one connecting element to form one toggle lever segment.

It is also extremely advantageous when one first connecting element is located in the region of the second ends of the two first lever elements and/or one second connecting element is located in the region of the second ends of the two second lever elements.

It is also advantageous when the first connecting element and/or the second connecting element has an opening through which the fixing element extends.

In addition, it is advantageous when the toggle lever unit includes multiple, in particular individual, toggle lever segments, which form a toggle lever assembly. It is also advantageous when the sealing unit has, in particular on the radial outer side thereof, a toggle lever cavity in which the toggle lever unit is located.

It is advantageous when the toggle lever cavity and the toggle lever unit are formed correspondingly to one another such that the toggle lever unit, in particular the individual toggle lever segments, is/are held in the toggle lever cavity in an interlocking and/or force-locking manner.

Furthermore, it is advantageous when the sealing unit is an, in particular open and/or elastic, sealing sleeve and/or has a separating slot.

Similarly, it is advantageous when the sealing unit includes at least one outer sealing element.

It is also advantageous when the at least one outer sealing element is designed and/or arranged such that the outer sealing element, when used as intended, is pressed outwards in the radial direction of the sealing device, in particular by the adjacent outer pressing portion of the toggle lever, which is adjacently situated in the axial direction, and/or by the adjacent axial pressing surface of the pressing element, which is adjacently situated in the axial direction, when the sealing element is moved from the neutral position into the sealing position.

Similarly, it is advantageous when the outer sealing element has, on the radially outer lateral surface thereof, a lubrication groove for accommodating a lubricant.

It is also extremely advantageous when the sealing unit includes one first outer sealing element, which is located between the first pressing element and the toggle lever unit in the axial direction of the sealing device.

It is advantageous when the sealing unit includes a second outer sealing element, which is located between the second pressing element and the toggle lever unit in the axial direction of the sealing device.

It is particularly advantageous when the sealing unit includes at least one inner sealing element.

It is also advantageous when the at least one inner sealing element is designed and/or arranged such that, when used as intended, the inner sealing element is pressed inwards in the radial direction of the sealing device, in particular by the first inner pressing portion and/or by the second inner pressing portion of the toggle lever, which is adjacently situated in the radial direction, when the sealing device is moved from the neutral position into the sealing position.

Similarly, it is advantageous when the inner sealing element is located between the two outer sealing elements in the axial direction of the sealing device.

It is also extremely advantageous when the inner sealing element is connected to the first outer sealing element and/or the second outer sealing element in the axial direction of the sealing device, in particular via the at least one compensation fold.

It is also advantageous when an insertable belt is located in the region of the inner sealing element, which insertable belt is located between the sealing unit and the toggle lever unit in the radial direction of the sealing device.

It is also advantageous when the pressing edge of the at least one toggle lever rests against the insertable belt radially from the outside.

It is similarly advantageous when the insertable belt is made of metal, in particular steel.

It is also extremely advantageous when the insertable belt is designed such that the diameter thereof is reducible, which insertable belt is formed, in particular, as an open ring and/or in multiple parts for this purpose.

It is also advantageous when the parts of the insertable belt overlap in the regions of the ends thereof.

It is particularly advantageous when the sealing device has an insertable disk, which can be positioned and/or is positioned in the interior of the sealing unit, in particular in the region of the inner sealing element.

It is advantageous when the insertable disk has at least one disk opening.

In another aspect, the present subject matter also relates to a toggle lever unit for a sealing device, in particular for use in a sealing device, specifically in particular for a sealing device according to the preceding description, wherein the aforementioned features can be present individually or in any combination. The toggle lever unit includes at least one toggle lever, which, when used as intended, can convert the axial force applicable by a pressing unit of the sealing device into a first radial force (e.g., a radially inwardly directed radial force) and/or into a second radial force (e.g., a radially outwardly directed radial force). The at least one toggle lever includes one first lever element, one second lever element, and at least one lever joint which hingedly interconnects the two lever elements. It is advantageous when the toggle lever unit is designed according to the preceding description, wherein the aforementioned features can be present individually or in any combination.

### BRIEF DESCRIPTION OF THE FIGURES

Further advantages of the invention are described in the following exemplary embodiments. Wherein:

FIG. 1 shows a perspective view of a sealing device for sealing an annular gap and/or for sealingly connecting two pipes,

FIG. 2 shows a perspective longitudinal sectional view of the sealing device shown in FIG. 1,

FIG. 3 shows a detailed sectional view of the longitudinal section of the sealing device shown in FIG. 2 in the region of a pressing element and an outer sealing element,

FIG. 4 shows a longitudinal section of the sealing device in a neutral position,

FIG. 5 shows a longitudinal section of the sealing device in a sealing position,

FIG. 6 shows a toggle lever segment of a toggle lever unit of the sealing device in a perspective view,

FIG. 7 shows the toggle lever segment from FIG. 6 of the toggle lever unit of the sealing device in a top view,

FIG. 8 shows the toggle lever segment from FIGS. 6 and 7 of the toggle lever unit of the sealing device in a side view,

FIG. 9 shows the toggle lever segment from FIGS. 6, 7, and 8 of the toggle lever unit of the sealing device in an end view,

FIG. 10 shows a pressing element of a pressing unit of the sealing device in a perspective front view,

FIG. 11 shows the pressing element from FIG. 10 of the pressing unit of the sealing device in a perspective rear view,

FIG. 12 shows a perspective view of a sealing unit of the sealing device,

FIG. 13 shows a perspective view of an insertable belt of the sealing device according to a first exemplary embodiment,

FIG. 14 shows a perspective view of the insertable belt of the sealing device, as shown in FIG. 13, according to the first exemplary embodiment in an exploded view,

FIG. 15 shows a perspective view of the insertable belt of the sealing device according to a second exemplary embodiment,

FIG. 16 shows a perspective view of an insertable disk of the sealing device,

FIG. 17 shows another exemplary embodiment of a toggle lever segment of a toggle lever unit of the sealing device in a top view,

FIG. 18 shows another exemplary embodiment of the pressing element of a pressing unit of the sealing device in a perspective front view, and

FIG. 19 shows a side view of the sealing device in a sealing position to which axial force is applied during the sealing of a wall opening.

### DETAILED DESCRIPTION

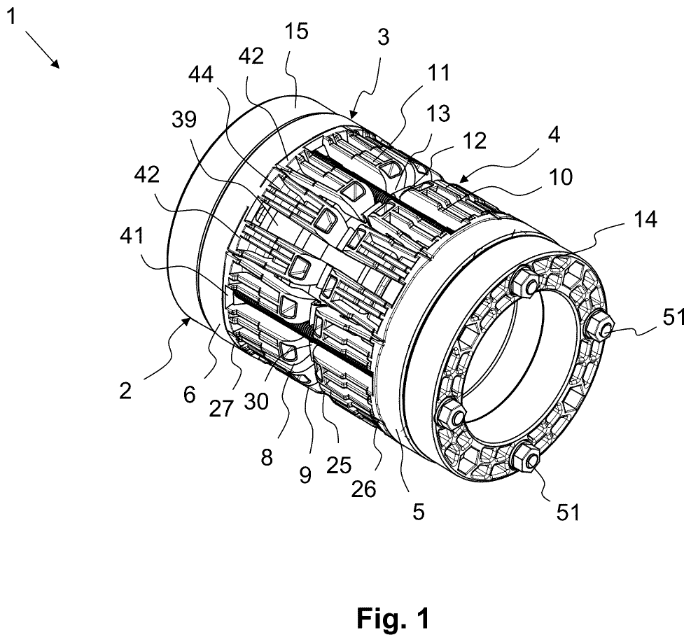

The exemplary embodiment of a sealing device 1 shown in FIGS. 1 through 14 illustrates various views and components of the device according to the present subject matter. In the following description, the same reference characters are used for features which are identical in terms of their embodiment and/or mode of operation. Unless explained otherwise in the following, their embodiment and/or mode of operation corresponds to the embodiment and/or mode of operation of the aforementioned features.

FIG. 1 shows a perspective view of a sealing device 1 which can be used to seal an annular gap and/or to sealingly connect two pipes. The sealing device 1 includes, according to FIG. 1, a pressing unit 2, which is able to generate an axial force in an axial direction of the sealing device. The sealing device 1 includes a sealing unit 3, which has at least one sealing element, such as at least one elastic sealing element 5, 6, 7. This at least one sealing element 5, 6, 7 can be pressed radially outwards and/or inwards by the pressing unit 2 when used as intended.

The sealing device 1 also includes at least one toggle lever unit 4 having at least one toggle lever 8, 9. This toggle lever 8, 9 is able to convert the axial force which can be generated by the pressing unit 2 into a radially inwardly directed first radial force and/or a radially outwardly directed second radial force.

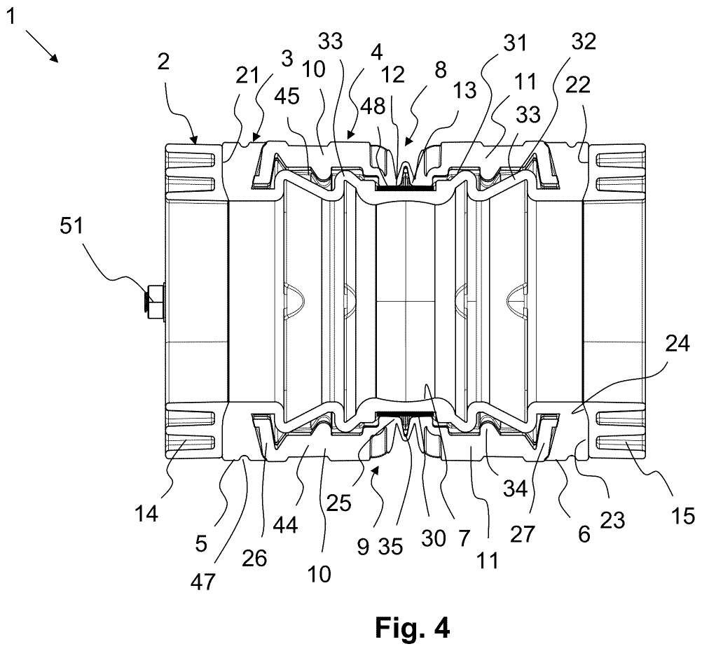

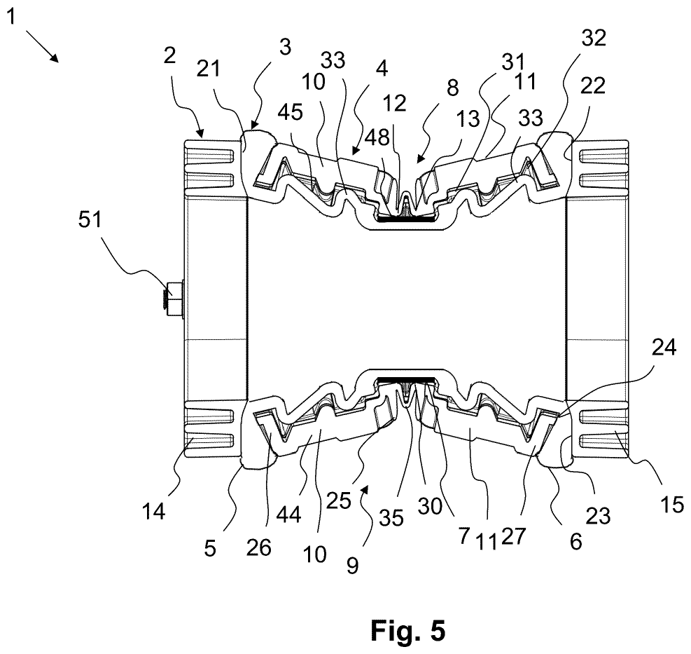

According to FIG. 4, in which a longitudinal section of the sealing device 1 is shown in a neutral position, the at least one toggle lever 8, 9 includes one first lever element 10, one second lever element 11, and at least one lever joint 12, 13, which hingedly interconnects the two lever elements 10, 11. FIG. 5 shows a longitudinal section of the sealing device 1 in a sealing position, which longitudinal section illustrates the mode of operation of the pressing unit 2.

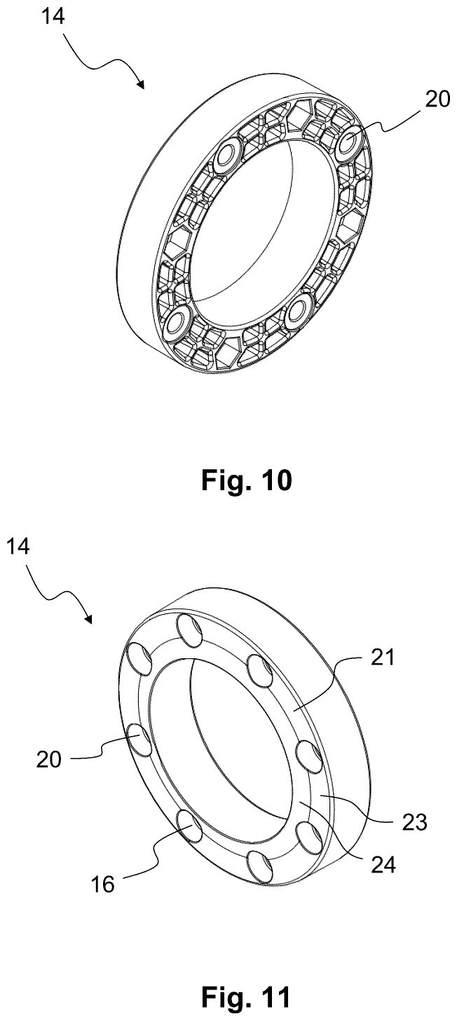

The pressing unit 2 has one first pressing element 14, in particular on one first end face of the sealing device 1, and one second pressing element 15 on a second end face of the sealing device, which pressing elements are shown in detail in FIGS. 10 and 11. Furthermore, another exemplary embodiment of the first and/or the second pressing element 14, 15 is shown in FIG. 18. The first and the second pressing elements 14, 15 are spaced apart from one another in the axial direction of the sealing device 1. This makes it possible to efficiently transmit the axial forces. In addition, it is advantageous when the first pressing element 14 and/or the second pressing element 15 is a press ring. Such a press ring preferably includes multiple, in particular interconnected, ring segments 56, as shown in FIG. 18.

The first pressing element 14 and/or the second pressing element 15 has, on the axial inner end face of the respective pressing element, at least one receiving recess 16 into which a sealing projection 17 on the sealing unit 3 is fitted. The receiving recess 16 is a blind hole in the present case. Furthermore, it becomes apparent in the figures that the receiving recess 16 in the first pressing element 14 and/or in the second pressing element 15 has an axial sealing surface 18, which corresponds to a sealing end face 19 of the sealing projection 17. The configuration of the sealing device 1 according to the figures additionally includes at least one fixing element 51, which enables a variable axial length adjustment between the first pressing element 14 and the second pressing element 15.

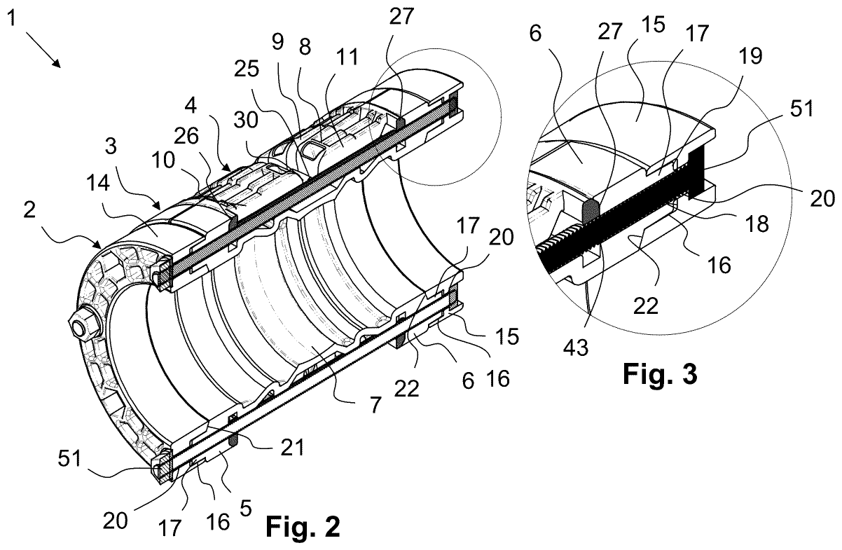

This fixing element 51 includes, in the present exemplary embodiment, both a screw and a nut in order to ensure the connection. As is suggested by the exemplary embodiments shown in the figures, both the first pressing element 14 and the second pressing element 15 have at least one axial through-cutout 20. This through-cutout 20 extends from an axial outer end face to the axial inner end face of the respective pressing elements 14, 15 through which the fixing element 51 extends. In FIGS. 2 and 3 it is apparent that the through-cutout 20 and the receiving recess 16 are coaxial, adjoin one another, and/or are located directly adjacent to one another.

In addition, the first pressing element 14 has one first axial pressing surface 21 and/or the second pressing element 15 has one second axial pressing surface 22, each of which includes an, in particular radially outer, first axial pressing region 23 and/or one, in particular radially inner, second axial pressing region 24. The first axial pressing region 23 extends parallel to the radial axis of the sealing device 1 in the longitudinal sectional view, as is suggested, in particular, by FIG. 4. Furthermore, it is suggested, in particular, by FIG. 4 that the second axial pressing region 24 is oriented obliquely to the radial axis, specifically such that the axial width of the first pressing element 14 and/or of the second pressing element 15 widens in the radially inward direction.

The present exemplary embodiment shows that the second axial pressing region 24 is designed as an annular projection projecting in the axial direction, which annular projection extends preferably along the entire circumferential direction of the sealing device 1. The sealing device 1 is movable between a neutral position, which is shown in FIG. 4, and a sealing position, to which axial force is applied and is shown in FIG. 5, as a result of which the flexibility and the adaptability to different sealing situations is increased.

In the neutral position, the two pressing elements 14, 15 have one first axial separation from one another. In addition, the two lever elements 10, 11 of the at least one toggle lever 8, 9 have one first exterior angle which is preferably less than or equal to 180°. As is suggested by the exemplary embodiment shown in the figure, this state is characteristic of the starting position of the sealing device 1. In the transition to the sealing position, the two pressing elements 14, 15 assume a comparatively smaller second axial separation. In parallel thereto, the two lever elements 10, 11 of the at least one toggle lever 8, 9 reduce the exterior angle of the lever elements as compared to the first exterior angle.

The first lever element 10 and/or the second lever element 11 is designed as a lever arm, which preferably extends in the axial direction of the sealing device 1. According to the present exemplary embodiment, the at least one toggle lever 8, 9 includes, specifically in the region of the at least one lever joint 12, 13 of the respective toggle lever, at least one inner pressing portion 25, 30. This is used to transmit the first radial force. The at least one toggle lever 8, 9 also includes at least one outer pressing portion 26, 27 for transmitting the second radial force. The inner pressing portion 25, 30 integrates a pressing edge 28, which preferably extends along the circumferential direction of the sealing device 1 and/or has a roll-off rounding. This configuration facilitates the force transmission and improves the contact surface, as is apparent in the figures.

The outer pressing portion 26, 27 has a pressing surface 29, which extends obliquely to the radial axis of the sealing device 1 in the longitudinal sectional view of the sealing device 1, specifically in the neutral position, which is shown in FIG. 4, and/or in the sealing position, which is shown in FIG. 5. In FIGS. 4 and 5 it becomes apparent that the pressing surface 29 of the toggle lever 8, 9 and the adjacent second axial pressing region 24 of the corresponding pressing element 14, 15 converge in a radially inward direction toward one another in a V-shape. This configuration optimizes the force flow and supports an effective seal between the components, which increases the performance of the sealing device 1 in the application of the sealing device.

The first lever element 10 has, in particular in the region of the first end thereof, which faces the lever joint 12, a first inner pressing portion 25. Additionally or alternatively, it is advantageous when one first outer pressing portion 26 is present in the region of the second end which faces away from the lever joint 12, 13. According to the exemplary embodiment shown in the figures, the second lever element 11 is provided with a second inner pressing portion 30 in the region of the first end of the second lever element, which first end faces the lever joint 13. Alternatively or additionally, it is advantageous when the second lever element 11 has a second outer pressing portion 27 in the region of the second end of the second lever element, which second end faces away from the lever joint 13.

FIG. 4 shows that the first lever element 10 and/or the second lever element 11 includes, on the radial inner side of the respective lever element, at least one receiving cavity 31, 32. In this receiving cavity, the sealing unit 3, in particular a compensation fold 33 extending in the circumferential direction, is at least partially accommodated and/or can be accommodated at least in the sealing position of the sealing device 1 shown in FIG. 5. As is apparent in the figures, the receiving cavity 31, 32 is an annular groove which extends preferably over the entire circumference of the sealing device 1 in the circumferential direction.

Furthermore, the first lever element 10 and/or the second lever element 11 has, on the radial inner side of the respective lever element, a first receiving cavity 31 and/or a second receiving cavity 32, which are spaced apart from one another in the axial direction of the sealing device 1. Between the first receiving cavity 31 and the second receiving cavity 32, a separating element 34 is formed on the first lever element 10 and/or on the second lever element 11, as shown in particular in FIG. 4.

The exemplary embodiment shown in FIG. 1 shows that the at least one lever joint 12, 13 can be designed as a flexural joint, in particular a material joint, and/or a rotary joint. An axis of rotation of the at least one lever joint 12, 13 is oriented in a transverse direction of the sealing device 1. As is suggested by the exemplary embodiment shown, the at least one toggle lever 8, 9 includes one first lever joint 12 and one second lever joint 13, which are preferably spaced apart from one another in the axial direction of the sealing device 1.

In FIG. 4 it is also apparent that the at least one toggle lever 8, 9 includes a spacer element 35 which is positioned between the two lever joints 12, 13 in the axial direction. This spacer element 35 decouples the two lever joints 12, 13 from one another and/or holds them spaced apart from one another, which enables a precise guidance and transmission of forces and thus contributes to the efficacy of the sealing device 1.

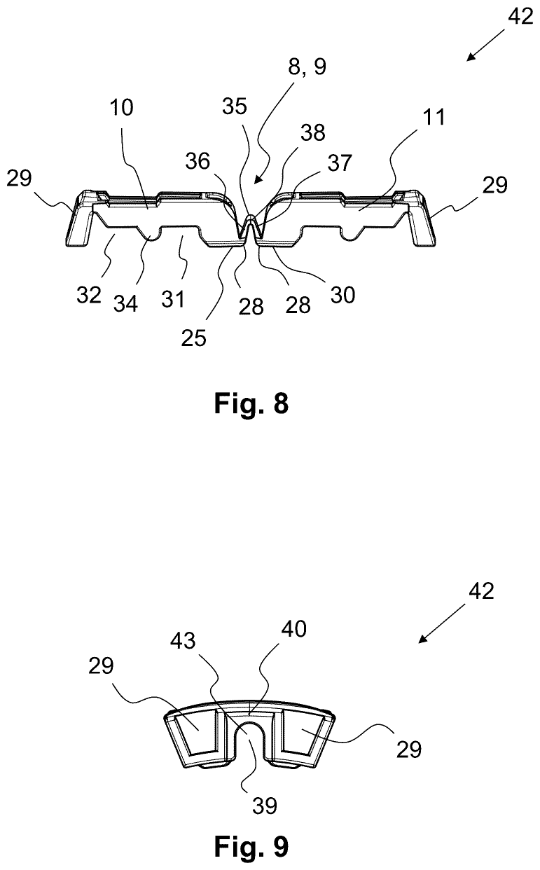

The spacer element 35, as is illustrated in particular in FIGS. 7 and 8, includes one first leg 36 and one second leg 37 as well as a connecting portion 38, which preferably rigidly interconnects the two legs 36, 37. The spacer element 35 has a V-shape in the longitudinal sectional view of the sealing device 1.

According to the exemplary embodiment shown, the toggle lever unit 4 has one first toggle lever 8 and one second toggle lever 9. These toggle levers are preferably designed according to the preceding description, wherein the aforementioned features can be present individually or in any combination. In particular, they are of identical design. The two toggle levers 8, 9 are spaced apart from one another in the circumferential direction of the sealing device 1. This embodiment allows for the formation of a movement cavity 39 between the first toggle lever 8 and the second toggle lever 9 in the circumferential direction of the sealing device 1. This movement cavity 39 is designed such that it accommodates the movement of the lever elements 10, 11 and/or of the lever joints 12, 13 of the two toggle levers 8, 9 when the sealing device 1 is transferred from the neutral position, which is shown in FIG. 4, into the sealing position, which is shown in FIG. 5.

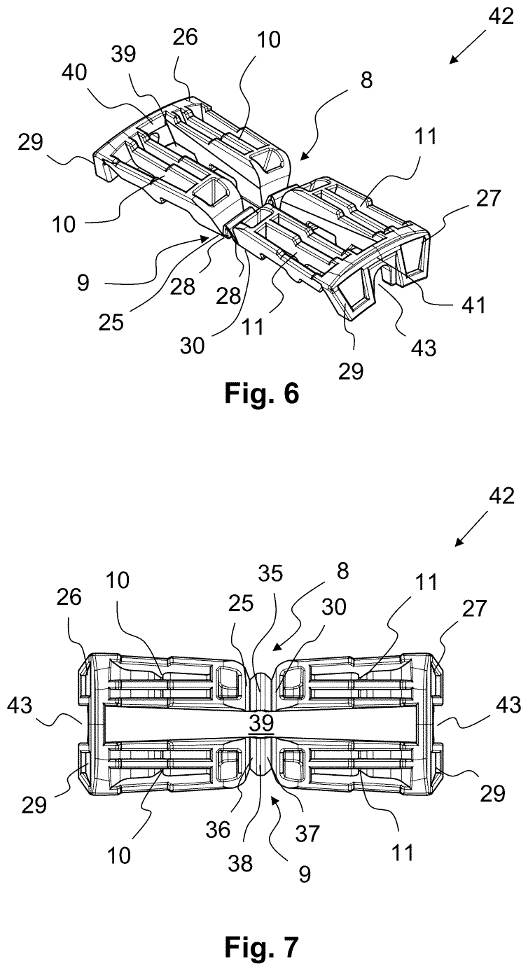

In FIG. 6 it is apparent that the first toggle lever 8 and the second toggle lever 9 are interconnected to form one toggle lever segment 42 via at least one connecting element 40, 41. One first connecting element 40 is positioned in the region of the second ends of the two first lever elements 10 and/or one second connecting element 41 is located in the region of the second ends of the two second lever elements 11. These connecting elements 40, 41 have an opening 43 through which the fixing element 51 extends, as is apparent, in particular, in FIG. 2.

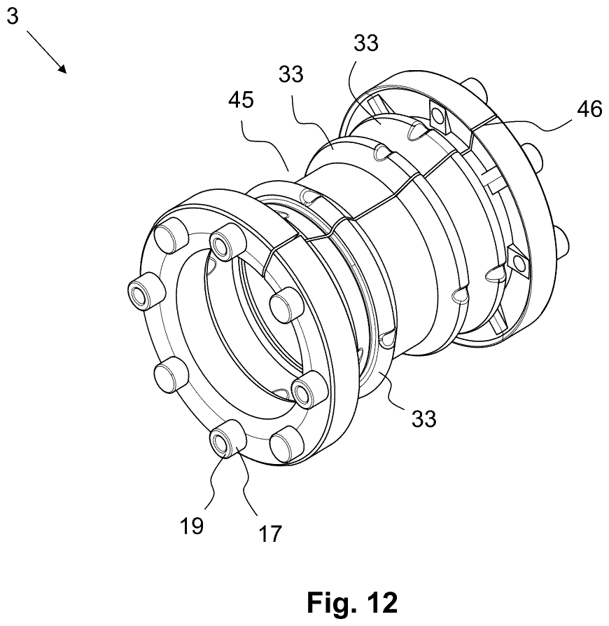

The toggle lever unit 4 includes multiple, in particular individual, toggle lever segments 42, which together form a toggle lever assembly 44 as shown in FIG. 1. The sealing unit 3 shown in FIGS. 4 and 12 has, in particular on the radial outer side thereof, a toggle lever cavity 45 in which the toggle lever unit 4 is placed. The toggle lever cavity 45 and the toggle lever unit 4 are matched to each other such that the toggle lever unit 4, in particular the individual toggle lever segments 42, are held in the toggle lever cavity 45 in an interlocking and/or force-locking manner. This arrangement shows that the sealing device 1 has high accuracy of assembly and stability, which is substantially significant for the function of the sealing device 1.

The sealing unit 3 is designed, in particular, as an open and/or elastic sealing sleeve and/or includes a separating slot 46, as shown in FIG. 12. As is shown in the figures, the sealing unit 3 includes at least one outer sealing element 5, 6. This is designed and/or positioned such that, when used as intended, it is pressed radially outwards in the direction of the radial axis of the sealing device 1, in particular by the adjacent outer pressing portion 26, 27 of the toggle lever 8, 9, which is adjacent in the axial direction, and/or by the adjacent axial pressing surface 21, 22 of the pressing element 14, 15, which is adjacent in the axial direction, when the sealing device 1 is moved from the neutral position into the sealing position.

According to the present exemplary embodiment, the outer sealing element 5, 6 has, on the radially outer lateral surface thereof, a lubrication groove 47 for accommodating a lubricant. This embodiment supports the function of the sealing device 1 by reducing the friction between the moving parts and thus allows for an efficient operation.

The sealing unit 3 includes a first outer sealing element 5, which is located between the first pressing element 14 and the toggle lever unit 4 in the axial direction of the sealing device 1. In addition, a second outer sealing element 6 is present in the sealing unit 3, which second outer sealing element is located between the second pressing element 15 and the toggle lever unit 4 in the axial direction of the sealing device 1.

The sealing unit 3 also includes at least one inner sealing element 7. This inner sealing element is designed and/or arranged such that, when used as intended, it is pressed radially inwards in the direction of the radial axis of the sealing device 1, specifically by the first inner pressing portion 25 and/or the second inner pressing portion 30 of the radially adjacent toggle lever 8, 9 as soon as the sealing device 1 transitions from the neutral position into the sealing position.

The figures show that the inner sealing element 7 is positioned between the two outer sealing elements 5, 6 in the axial direction of the sealing device 1. The inner sealing element is connected to the first outer sealing element 5 and/or the second outer sealing element 6, in particular, via the at least one compensation fold 33. This arrangement enables an optimal seal and pressure distribution within the sealing device 1, which increases the functional capability and reliability of the seal.

The sealing unit 3 in the exemplary embodiment shown in the figures is designed, in particular, as an open and/or elastic sealing sleeve and/or includes a separating slot 46. The sealing unit includes at least one outer sealing element 5, 6, which is designed and/or arranged such that, when used as intended, it is pressed outwards in the radial direction of the sealing device 1, in particular by the adjacent outer pressing portion 26, 27 of the toggle lever 8, 9, which is adjacently situated in the axial direction, and/or by the adjacent axial pressing surface 21, 22 of the pressing element 14, 15, which is adjacently situated in the axial direction. This functionality appears when the sealing device 1 is moved from the neutral position into the sealing position, as is shown in the figures.

The outer sealing element 5, 6 has, on the radially outer lateral surface thereof, the lubrication groove 47, which is used to accommodate the lubricant. The first outer sealing element 5 of the sealing unit 3 is positioned between the first pressing element 14 and the toggle lever unit 4 as shown in the figures, whereas the second outer sealing element 6 is located between the second pressing element 15 and the toggle lever unit 4. In addition, the sealing unit 3 includes at least the inner sealing element 7. This inner sealing element 7 is designed and/or arranged such that, when used as intended, it is pressed inwards in the radial direction of the sealing device 1, in particular by the first inner pressing portion 25 and/or by the second inner pressing portion 30 of the toggle lever 8, 9, which is adjacently situated in the radial direction. This takes place during the transition of the sealing device 1 from the neutral position into the sealing position.

Furthermore, the inner sealing element 7 in the figures is positioned between the two outer sealing elements 5, 6 in the axial direction of the sealing device 1. The inner sealing element is connected to the first outer sealing element 5 and/or the second outer sealing element 6, in particular, via the at least one compensation fold 33.

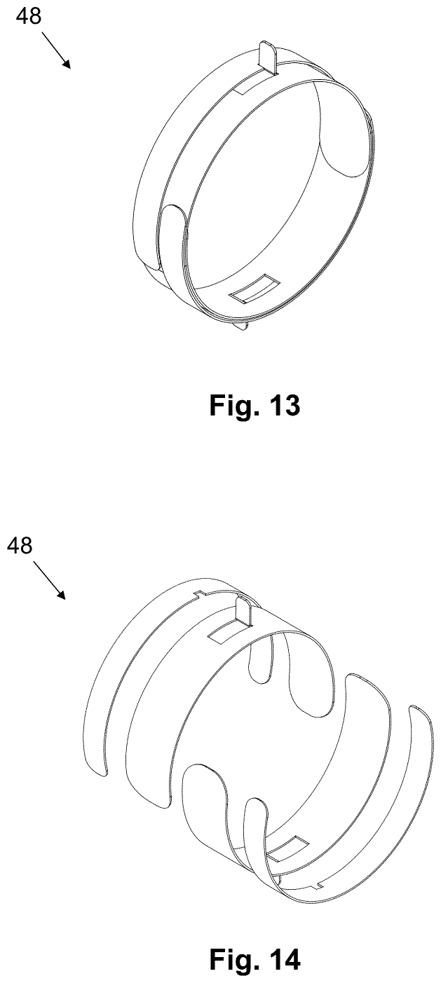

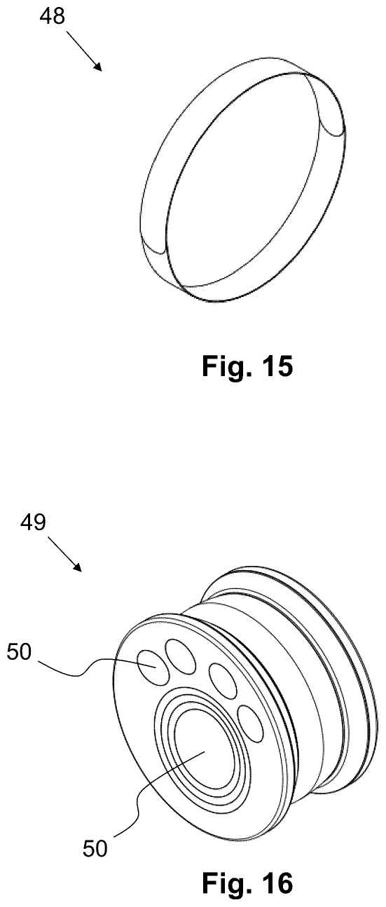

An insertable belt 48 is positioned in the region of the inner sealing element 7, as is suggested in particular by FIGS. 4 and 5, which insertable belt is located between the sealing unit 3 and the toggle lever unit 4 in the radial direction of the sealing device 1. The pressing edge 28 of the at least one toggle lever 8, 9 rests against the insertable belt 48 radially from the outside. The insertable belt 48 is made of a metal, in particular of steel, and/or is designed such that the diameter thereof can be reduced. To this end, as is suggested by the embodiments shown in FIGS. 13 and 15, the insertable belt is an open ring and/or is in multiple parts, wherein the parts of the insertable belt 48 overlap in the region of the ends thereof, which allows for a variable adaptation to different diameters.

In addition, the sealing device 1 according to FIG. 16 has an insertable disk 49, which can be positioned and/or is already positioned in the interior of the sealing unit 3, in particular in the region of the inner sealing element 7. The insertable disk 49 has at least one disk opening 50 which supports the assembly and adaptation to different circumstances within the sealing device 1, as is made apparent in the figures.

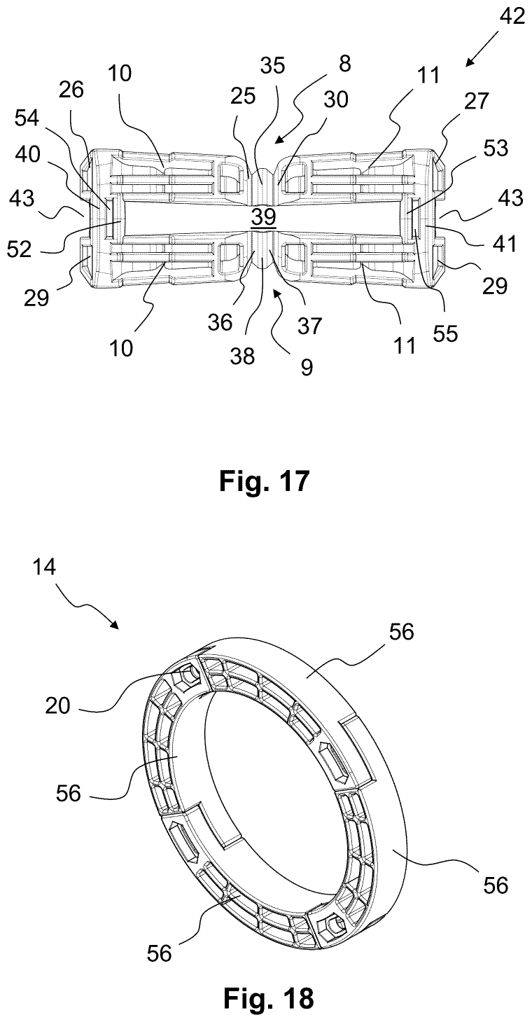

FIG. 17 shows another exemplary embodiment of a toggle lever segment 42 of a toggle lever unit 4 of the sealing device 1 in a top view. In the following description, the same reference characters are used for features which are identical in terms of their embodiment and/or mode of operation. Unless explained otherwise, the embodiment and/or mode of operation thereof corresponds to the embodiment and/or mode of operation of each of the aforementioned features. In contrast to the exemplary embodiment shown in FIGS. 6 through 9, the toggle lever segment 42 shown in FIG. 17 includes one first stiffener 52. The first stiffener 52 is located adjacent to the first connecting element 40 and is spaced apart therefrom in the longitudinal direction of the toggle lever segment 42. A first open space 54 is formed between the first connecting element 40 and the first stiffener 52 in the longitudinal direction of the toggle lever segment 42. The toggle lever segment 42 shown in FIG. 17 also includes one second stiffener 53. The second stiffener 53 is located adjacent to the second connecting element 41 and is spaced apart therefrom in the longitudinal direction of the toggle lever segment 42. A second open space 55 is formed between the second connecting element 41 and the second stiffener 53 in the longitudinal direction of the toggle lever segment 42. The two open spaces 54, 55 are separated from the movement cavity 39 by the respective adjacent stiffener 52, 53. Apart therefrom, the exemplary embodiment shown in FIG. 17 is designed similarly to the first exemplary embodiment, which is shown in FIGS. 6 through 9.

FIG. 18 shows, as mentioned above, another exemplary embodiment of the pressing element 14, 15 in a perspective outer view. In the following description, the same reference characters are used for features which are identical in terms of their embodiment and/or mode of operation. Unless explained otherwise, their embodiment and/or mode of operation corresponds to the embodiment and/or mode of operation of each of the aforementioned features. In contrast to the above-described first exemplary embodiment, which is apparent in detail, in particular, in FIGS. 10 and 11, the second exemplary embodiment, which is shown in FIG. 18, comprises multiple, in particular interconnected, ring segments 56. These are closed to form a ring. Furthermore, the ring segments 56 interlockingly engage into one another at the facing ring ends thereof. To this end, the ring segments have a stepping in the region of the ring ends thereof. The through-cutouts 20 in this exemplary embodiment are formed in an overlapping region, in particular in the region of the stepping. When the fixing element 51 has been guided through, the overlapping ring segments 56 are interconnected by the fixing element 51. It is advantageous when the ring segments 56 can be moved toward one another in the circumferential direction, even when the fixing element 51 has been guided through, so that the diameter of the pressing element 14, 15 is adjustable. Preferably, the through-cutouts 20 are designed, for this purpose, as slots extending in the circumferential direction. Additionally or alternatively, play is formed in the circumferential direction between the fixing element 51 and the wall of the through-cutout 20.

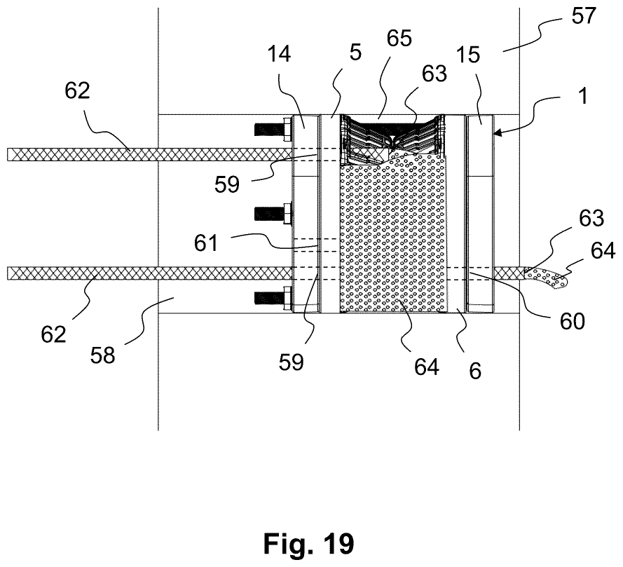

FIG. 19 shows a side view of the sealing device 1 in a sealing position, to which axial force is applied, during the sealing of an annular gap, which is formed between a wall opening 58 in a wall 57 and a pipe (not shown here). In the operating position shown, the two outer sealing elements 5, 6 are pressed radially outwards against the wall of the wall opening 58 and the inner sealing element 7 (cf. FIG. 5) is pressed radially inward against the outer circumference of the pipe (not shown here).

The sealing device 1 is designed according to the preceding description, wherein the aforementioned features can be present individually or in any combination. As is suggested by FIG. 19, the sealing device 1 includes at least one filling opening 59, 60. This at least one filling opening 59, 60 extends from one of the two end faces of the sealing device 1 in the axial direction through the corresponding pressing element 14, 15 and/or through the sealing unit 3 to the toggle lever unit 4. Through this at least one filling opening 59, 60, an injection element 62, in particular an injection cannula, can be introduced into the sealing device 1 and/or guided completely through the sealing device. The injection element 62 has, on the end thereof, an injection opening 63 via which an injection material 64, in particular a resin, can be injected. The injection material 64 is preferably designed such that it is liquid for injection and/or increases in volume during curing. In particular, an expansion resin is used for this purpose.

According to FIG. 19, the sealing element 1 has one first filling opening 59. Via this first filling opening 59, the injection element 62 is introduced into a central cavity 65, which is formed between the radially inner toggle lever unit 4 and the radially outer wall of the wall opening 58. This central cavity 65 is filled, after the insertion, with the injection material 64. The sealing device 1 has at least one vent opening 61 so that air located in the central cavity 65 can escape during the filling process. The vent opening is also located on the end face. Furthermore, the vent opening 61 extends from the end face of the sealing device 1 in the axial direction through the corresponding pressing element 14 and/or through the sealing unit 3 to the toggle lever unit 4 or into the central cavity 65.

Additionally or alternatively, the back side—on the end face—of the sealing device 1 according to FIG. 19 can also be filled. For this purpose, the sealing device 1 has one second filling opening 60. This second filling opening 60 extends through the second pressing element 15 and the second outer sealing element 6 of the sealing unit 3. Consequently, the injection element 62 can be additionally guided through the second filling opening 60, so that the injection element 62 extends from the first end face through the first filling opening 59 beyond the second end face of the sealing device 1. As a result, the back side of the sealing device 1 can also be filled with injection material 64.

The at least one first filling opening 59, the second filling opening 60, and/or the vent opening 61 can be closed and, if necessary, bored.

### LIST OF REFERENCE CHARACTERS

1 sealing device
2 pressing unit
3 sealing unit
4 toggle lever unit
5 first outer sealing element
6 second outer sealing element
7 inner sealing element
8 first toggle lever
9 second toggle lever
10 first lever element
11 second lever element
12 first lever joint
13 second lever joint
14 first pressing element
15 second pressing element
16 receiving recess
17 sealing projection
18 sealing surface
19 sealing end face
20 through-cutout
21 first axial pressing surface
22 second axial pressing surface
23 first axial pressing region
24 second axial pressing region
25 first inner pressing portion
26 first outer pressing portion
27 second outer pressing portion
28 pressing edge
29 pressing surface
30 second inner pressing portion
31 first receiving cavity
32 second receiving cavity
33 compensation fold
34 separating element
35 spacer element
36 first leg
37 second leg
38 connecting portion
39 movement cavity
40 first connection element
41 second connection element
42 toggle lever segment
43 opening
44 toggle lever assembly
45 toggle lever cavity
46 separating slot
47 lubrication groove
48 insertable belt
49 insertable disk
50 disk opening
51 fixing element
52 first stiffener
53 second stiffener
54 first open space
55 second open space
56 ring segment
57 wall
58 wall opening
59 first filling opening
60 second filling opening
61 vent opening
62 injection element
63 injection opening
64 injection material
65 central cavity

1-15. (canceled)

16. A sealing device for sealing an annular gap, the sealing device comprising:
a pressing unit configured to apply an axial force in an axial direction of the sealing device;
a sealing unit including at least one sealing element configured to be pressed by the pressing unit outwards and/or inwards in a radial direction of the sealing device; and
at least one toggle lever unit including at least one toggle lever configured to convert the axial force applied by the pressing unit into a radially inwardly directed first radial force and/or into a radially outwardly directed second radial force,
wherein the at least one toggle lever comprises a first lever element, a second lever element, and at least one lever joint that hingedly interconnects the first and second lever elements.

17. The sealing device of claim 16, wherein the pressing unit comprises a first pressing element positioned on a first end face of the sealing device and a second pressing element positioned on a second end face of the sealing device.

18. The sealing device of claim 17, wherein the pressing unit further comprises at least one fixing element that interconnects the first and second pressing elements in such a way that an axial length defined between the first and second pressing elements is variable.

19. The sealing device of claim 17, wherein the first pressing element comprises a first axial pressing surface and the second pressing element comprises a second axial pressing surface, the first axial pressing surface and/or the second axial pressing surface comprising a radially outer, first axial pressing region and/or a radially inner, second axial pressing region.

20. The sealing device of claim 19, wherein the first axial pressing region extends parallel to a radial axis of the sealing device in a longitudinal sectional view of the sealing device and the second axial pressing region extends obliquely to the radial axis in the longitudinal sectional view of the sealing device.

21. The sealing device of claim 20, wherein the second axial pressing region extends obliquely to the radial axis such that an axial width of the first pressing element and/or of the second pressing element widens in the radially inward direction.

22. The sealing device of claim 17, wherein the sealing device is movable between a neutral position and a sealing position, and wherein:
the first and second pressing elements, when in the neutral position with respect to one another, have a first axial separation and/or the first and second lever elements of the at least one toggle lever have a first exterior angle relative to each other; and/or
the first and second pressing elements, when in the sealing position, have a second axial separation that is smaller in comparison to the first axial separation, and/or the first and second lever elements of the at least one toggle lever have a second exterior angle relative to each other that is smaller in comparison to the first angle.

23. The sealing device of claim 17, wherein:
the sealing unit comprises a first outer sealing element located between the first pressing element and the at least one toggle lever unit in the axial direction of the sealing device, wherein the sealing unit comprises a second outer sealing element located between the second pressing element and at least one the toggle lever unit in the axial direction of the sealing device; and/or
the sealing unit comprises at least one inner sealing element.

24. The sealing device of claim 16, wherein the at least one toggle lever comprises, in a region of the lever joint thereof, at least one inner pressing portion for transmitting the first radial force and/or at least one outer pressing portion for transmitting the second radial force.

25. The sealing device of claim 24, wherein the inner pressing portion comprises a pressing edge that extends in a circumferential direction of the sealing device and/or has a roll-off rounding.

26. The sealing device of claim 25, wherein the outer pressing portion comprises a pressing surface that extends obliquely to a radial axis of the sealing device in a longitudinal sectional view of the sealing device.

27. The sealing device of claim 16, wherein the first lever element comprises a first inner pressing portion in a region of a first end of the first lever element facing the lever joint and a first outer pressing portion in a region of a second end of the first lever element facing away from the lever joint, wherein the second lever element comprises a second inner pressing portion in a region of a first end of the second lever element facing the lever joint and a second outer pressing portion in a region of a second end of the second lever element facing away from the lever joint.

28. The sealing device of claim 16, wherein the first lever element and/or the second lever element comprises, on a radial inner side thereof, at least one receiving cavity in which a compensation fold of the sealing unit is configured to be at least partially accommodated.

29. The sealing device of claim 16, wherein the at least one lever joint comprises a first toggle joint and a second toggle joint, with the first and second toggle joints being spaced apart from each other in the axial direction of the sealing device.

30. The sealing device of claim 29, wherein the at least one toggle lever further comprises a spacer element located between the first and second toggle joints in the axial direction and decouples the first and second toggle joints from each other and/or spaces the first and second toggle joints apart from each other, the spacer element comprising a first leg, a second leg, and a connecting portion that interconnects the first and second legs.

31. The sealing device of claim 16, wherein the at least one toggle lever comprises a first toggler lever and a second toggle lever, the first and second toggle levers being spaced apart from one another in the circumferential direction of the sealing device such that a movement cavity is formed between the first toggle lever and the second toggle lever in the circumferential direction of the sealing device, the movement cavity being configured such that the first and second lever elements and/or the at least one lever joint can move into the movement cavity when the sealing device is moved from a neutral position into a sealing position.

32. The sealing device of claim 31, wherein the first toggle lever and the second toggle lever are connected to form a toggle lever segment (42) via at least one connecting element (40, 41), the toggle lever unit comprising a plurality individual toggle lever segments that form a toggle lever assembly.

33. The sealing device of claim 16, wherein the sealing unit, on a radial outer side thereof, comprises a toggle lever cavity in which the toggle lever unit is located.

34. A toggle lever unit for a sealing device, wherein the sealing device comprises a pressing unit configured to apply an axial force in an axial direction of the sealing device and a sealing unit including at least one sealing element configured to be pressed by the pressing unit outwards and/or inwards in a radial direction of the sealing device, the toggle lever unit comprising:
at least one toggle lever configured to convert the axial force applied by the pressing unit into a radially inwardly directed first radial force and/or into a radially outwardly directed second radial force,
wherein the at least one toggle lever comprises a first lever element, a second lever element, and at least one lever joint that hingedly interconnects the first and second lever elements.
